(19) United States
(12) Patent Application Publication
(10) Pub. No.: US 2002/0074824 A1
(43) Pub. Date: Jun. 20, 2002

(54) Windup shade for simplified assembly in a window

(76) Inventors: Werner P. Schlecht, Vaihingen (DE); Herbert Walter, Ebersbach (DE)

Correspondence Address: VENABLE, Post Office Box 34385, Washington, DC, 20043-9998, US

(21) Appl. No.: 10/015,693

(22) Filed: Dec. 17, 2001

(30) Foreign Application Priority Data
Dec. 16, 2000 (DE) 100 62 690.4

(51) Int. Cl. B60J 3/02

(52) U.S. Cl. 296/143

(57) ABSTRACT

A windup window shade comprises a preassembled unit, consisting at least of the windup shaft, the associated seating elements and a frame tubing connecting the seating elements. In addition, the electric drive motor and guide tubes for guiding thrust members for actuating the windup window shade are part of the preassembled component. The windup window shade is connected with a traction rod, whose ends are guided in the guide rail elements, which are also a part of the component.

In a vehicle body a flange is provided for fastening a window pane. The flange is simultaneously used as a fastening for the guide rails so that the latter can approach the window pane opening as closely as possible without appearing as a distraction.

Modern automobile body shapes are distinguished by relatively large window areas. Because of strong sunlight, the large window areas result in considerable heat generation in the interior of the vehicle and, in connection with vehicles with air conditioning, this large heat generation results in a not inconsiderably use of energy in order to counteract the heating effects on the vehicle.

For this reason, motor vehicles are increasingly equipped with windup window shades.

In this connection it is known to provide two guide rails in which the traction rod of the window shade web is guided in front of the rear window. Actuation takes place by means of the thrust elements running in the guide rails.

The guide rails for such windup window shades are quite filigreed bodies. They are made of a light alloy and are accordingly very sensitive to bending. A small force is already sufficient to destroy them, as long as they are not fastened on a stable supporting element.

It is therefore difficult to assemble the guide rails accurately in the vehicle.

Moreover, it is necessary to assemble the guide rails in the correct position in respect to the windup shaft, or the windup shaft in the correct position in respect to the guide rails. The traction rod can only be threaded into the guide rails after the windup shaft and the guide rails have been assembled.

Considerable difficulties in performing this filigreed work arise during assembly on the assembly line.

Based on the foregoing it is the object of the invention to considerably ease the assembly of the windup window shade on the assembly line when the vehicle is assembled and/or to achieve a well covered arrangement of the guide rails, so that they cause little visual clutter and are protected from damage.

In accordance with the invention, this object is attained by means of the windup window shade having the characteristics of claim 1, or the vehicle body, or the door for a motor vehicle, having the characteristics of claim 32.

The considerable simplification of the assembly arises from the seating means for the windup shaft being fastened on each other via connecting means, so that a pre-assembly is possible to this extent. It is no longer necessary during assembly on the assembly line to assemble the individual parts of the windup window shade in the correct position in relation to each other and to thread the movable elements into them in order to arrive at a functionally capable windup window shade. Instead, these elements can already be put together by the manufacturer, which makes assembly on the assembly line simpler, because it is only required to insert a pre-assembled component.

In this connection it is possible to provide the connecting means and/or the seating means with appropriate means for fastening these elements in the vehicle.

Assembly can be even more simplified if the component has the drive motor and the guide tubes for the drive members. Finally, an almost complete pre-assembly of the component is possible if the component additionally contains the guide rails, or at least a section thereof. By means of this the complete pre-assembly of the windup window shade by the manufacturer is possible.

The guide rails can be produced in two parts. The one part is fixedly connected with the seating means, while the other part of each guide rail can be connected to the first part by pushing it in. A further option lies in connecting the two parts of each guide rail by means of a hinge. The hinge can be a hinge with axial hinge pins, or a film hinge, or a predetermined breaking point.

Use of a hinge makes it possible to achieve a very compact component, which is delivered to the assembly line. By removing or folding up the respective parts of the guide rails a component is produced, from which no parts project away.

Because the hinge is practically only actuated twice, namely in the sense of folding it up after the assembly by the manufacturer, and in the sense of erecting it during assembly on the vehicle, the hinge can also be formed by predetermined breaking points, which can also be considered to be film hinges. In this way there is the opportunity, even when using guide rails made of extruded aluminum profiles, to notch the guide rails several times from the back. Because of the notch, two narrow strips of material remain next to the slit, which can be bent back and forth several times without breaking. The use of several notches reduces the amount of deformation occurring on a pair of strips when folding up the respective guide rail section.

The guide rails are advantageously arranged for a material or interlocking connection with the vehicle body. To this end they can be either provided with adhesive surfaces or with flange-shaped strips suitable for being screwed or glued on. A connection by means of rivets, for example blind rivets, is also conceivable.

If the respective guide rail is provided with a fastening flange, the flange can also be glued in between the window pane and the body.

Driving of the windup window shade is suitably performed by means of drive members, which are preferably interlocking connected with an electric motor. By means of this a synchronous drive of both ends of the traction rod is assured over a long operating time. The drive members are linearly shaped elements, which are provided with teeth on the outside. The teeth are constituted by a circumferential helix-shaped rib.

The guidance of the drive members to the guide rails takes place inside tubes in order to avoid buckling of the thrust members. The arrangement resembles a Bowden cable.

With a very simple embodiment, the guide tubes can have the same cross-sectional profile as the guide rails, and they can even make a transition in one piece into each other.

In connection with the use of a vehicle body, the arrangement becomes particularly simple and very advantageous from a design view if the guide rails are provided directly on the edge of the window opening and are connected there with the vehicle body. This applies in particular to doors with windows which are movable.

Customarily window openings for stationary windows in modern vehicle bodies are provided with a circumferential fold, which permits the creation of a projecting flange. This flange is used as the fastening surface for the window pane. The edge of the window pane is glued to the flange. The flange is preferably suitable for attaching the guide rails, in fact the guide rail can be glued by its own flange between the window pane and the vehicle body flange.

This arrangement offers the considerable advantage that during the assembly on the assembly line the windup window shade can be assembled without difficulties, and no threading through a window opening is required.

Further than that, the fold created by the flange offers space from the start for a space-saving placement of the guide rail, so that it is not visible from the interior.

Attachment of the guide rail on the flange can also be provided by means of a groove formed in it, which acts together with a rib formed on the vehicle body flange.

Finally, it is possible to form the guide rail, or at least a portion of the guide rail, directly integrally in the interior liner, so that the guide rail is composed of a short section, which is a part of the pre-assembled unit, and a longer section, which has been provided by injection molding in the plastic material of the lateral element.

Further embodiments of the invention are inter alia subject of dependent claims. It is intended here that also those combinations of characteristics are considered to be claimed, for which there is no explicit exemplary embodiments.

Exemplary embodiments of the subject of the invention are represented in the drawings. Shown are in:

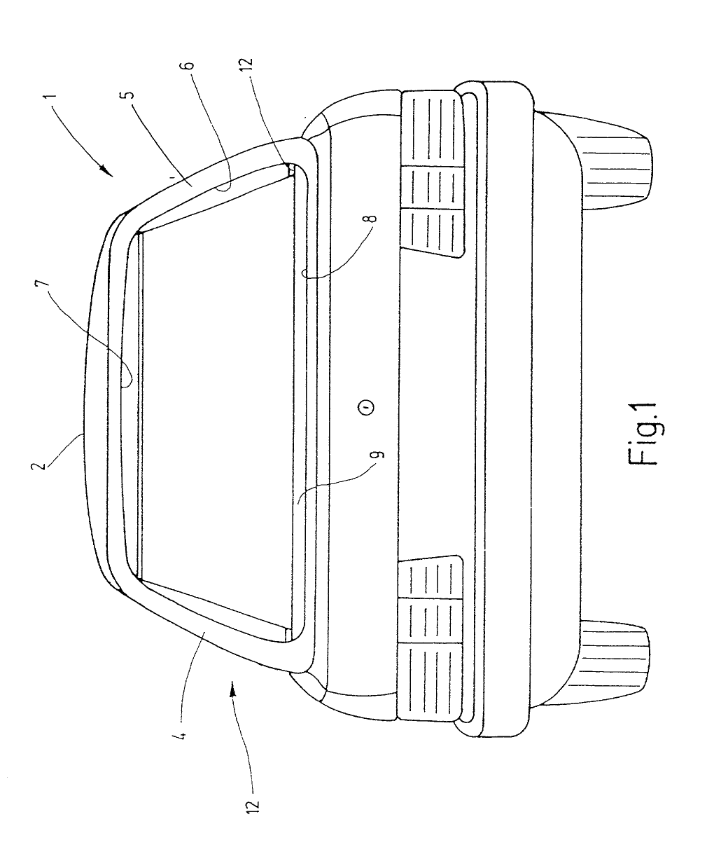

FIG. 1, a passenger car in a rear view, showing an extended rear windup window shade in accordance with the invention in the extended state,

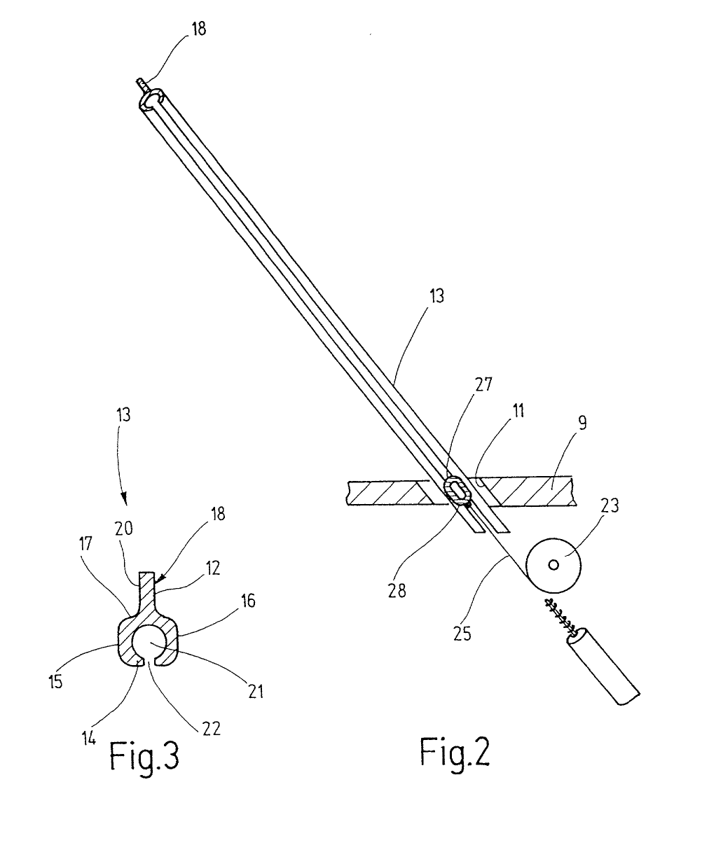

FIG. 2, the basic structure of the rear windup window shade in accordance with FIG. 1 in a view from above,

FIG. 3, the guide rail of the rear windup window shade in accordance with FIG. 1 in a cross-sectional view,

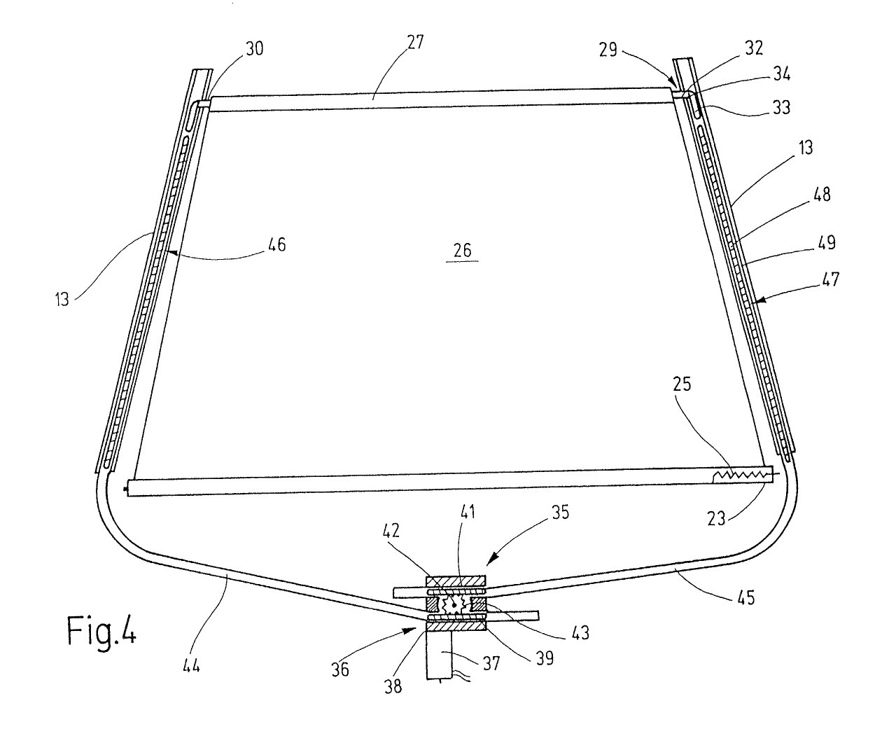

FIG. 4, the cooperation of the individual parts and the drive mechanism of the rear windup window shade in accordance with FIG. 1 in a simple schematic representation,

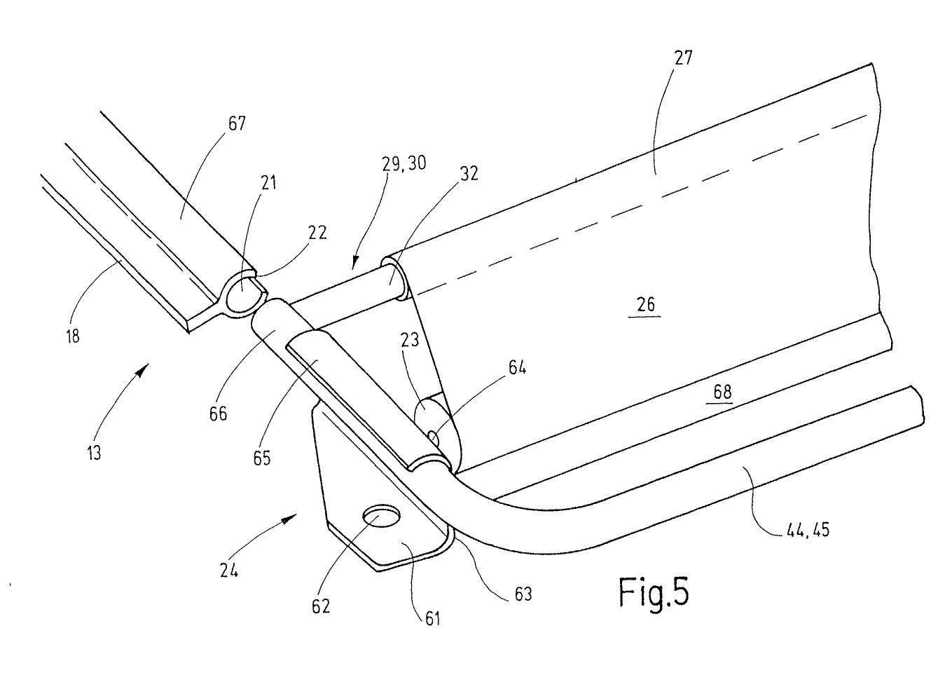

FIG. 5, the pre-assembled unit, consisting of the windup shaft, seating brackets, window shade web and traction rod, in a broken-off schematic view, wherein the guide rail is intended to be pushed together,

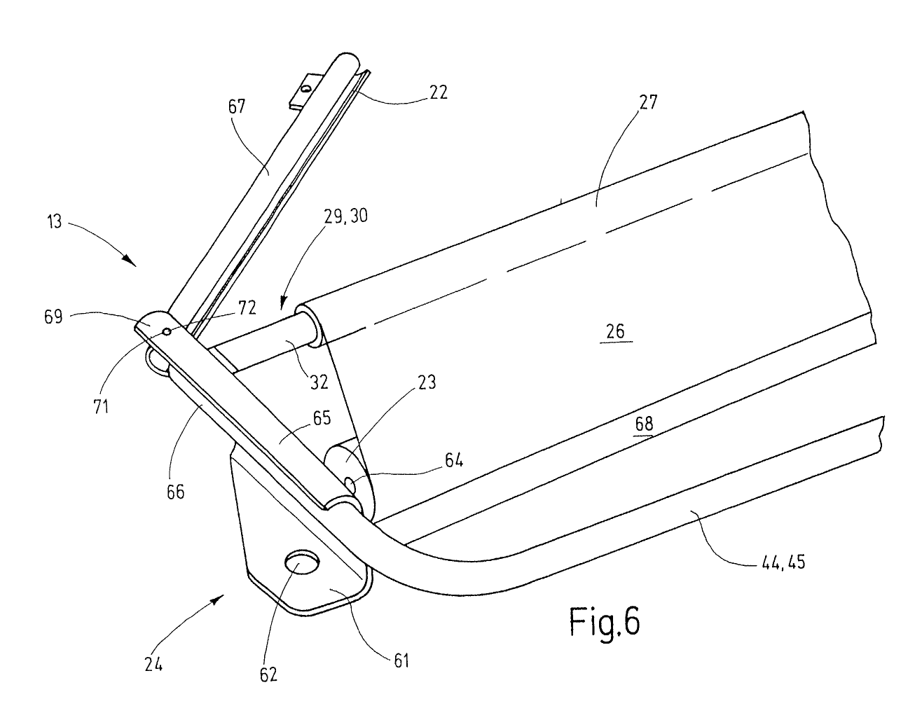

FIG. 6, the pre-assembled unit, consisting of the windup shaft, seating brackets, window shade web and traction rod, in a broken-off schematic view, wherein the guide rail is provided with a hinge,

FIG. 7, the pre-assembled unit, consisting of the windup shaft, seating brackets, window shade web and traction rod, in a broken-off schematic view, wherein the guide rail is provided with a predetermined bending point,

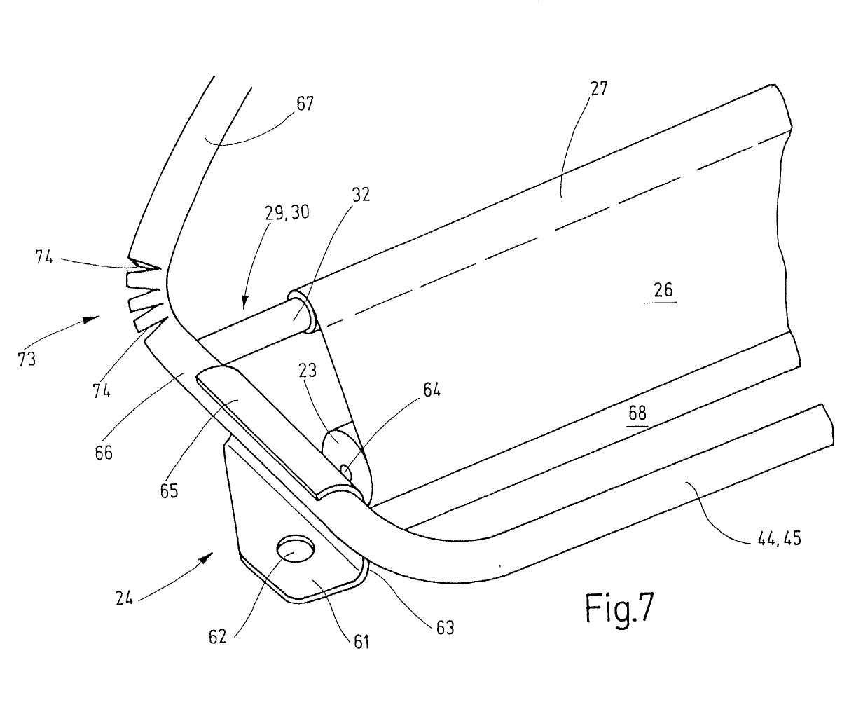

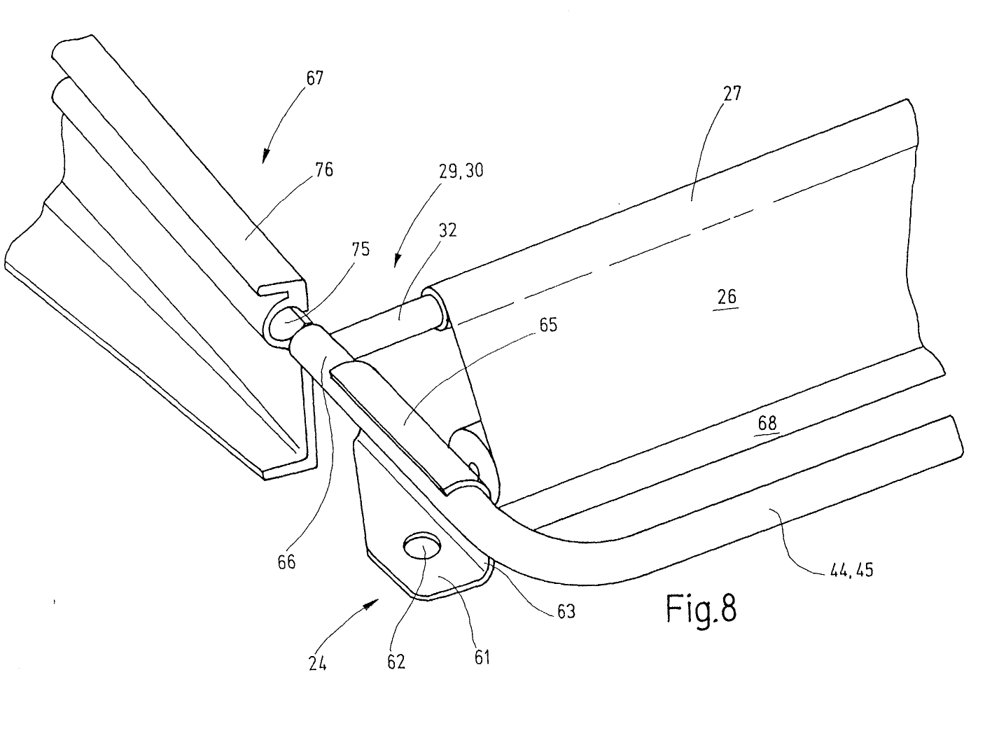

FIG. 8, the pre-assembled unit, consisting of the windup shaft, seating brackets, window shade web and traction rod, in a broken-off schematic view, wherein a portion of the guide rail is formed in a portion of the interior liner,

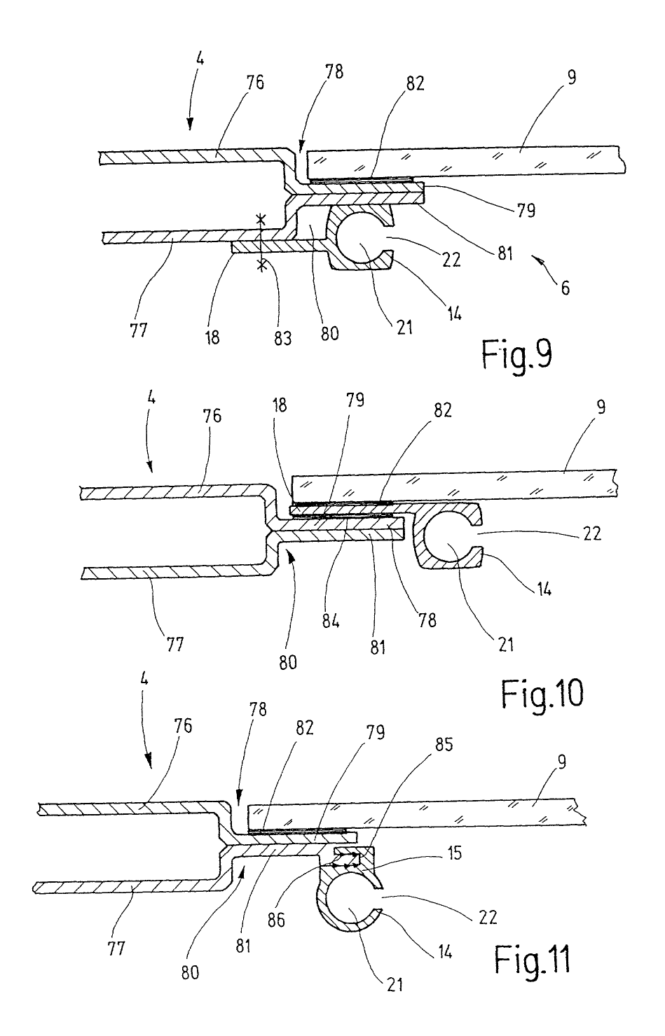

FIGS. 9 to 13, various connections between the guide rail and the vehicle body, and

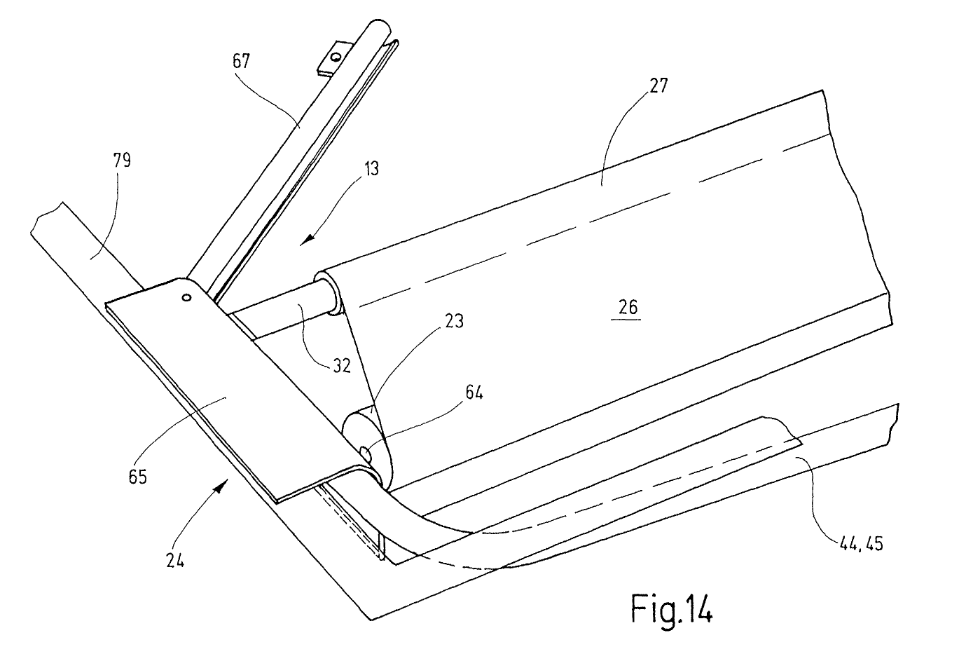

FIG. 14, the pre-assembled unit, consisting of the windup shaft, seating brackets, window shade web and traction rod, in a broken-off schematic view, representing the assembly on the window flange.

In a schematic representation, FIG. 1 shows a rear view of a passenger car 1, having a roof 2, a trunk 3, as well as two C-pillars 4 and 5. A rear window opening 6, which is bordered at the top by a rear edge 7 of the roof and on the bottom by a lower window edge 8, is located between the two C-pillars 4 and 5. A rear window pane 9 is seated in the rear window opening 6 in a known manner, for example glued in by means of an adhesive.

A rear window shelf 11 is located in the interior of the passenger car 1 in front of the rear window pane 9, which extends between the lower window edge 8 and the backrest of a rear seat, not visible in the drawing. A straight outlet slit 12 extends in the rear window shelf 11.

The outlet slit 12 is a part of a rear windup window shade 12, whose basic structure is shown, greatly schematized, in a view from above in FIG. 2.

The rear windup window shade 12 has two guide rails 13, which are fastened next to the lateral edges of the rear window opening 6 on both C-pillars 4 and 5.

Because of the cut-open basic representation, only one guide rail 13, which for example is fastened on the C-pillar 5, can be seen in FIG. 2. The type of fastening in accordance with the invention is explained in detail further down below.

The guide rail 13 has the profile represented in FIG. 3. It is essentially square in cross section, with rounded off edges, and is bordered by a front 14, two lateral walls 15 and 16, as well as by a back 17. A strip-like fastening flange 18 extends from the back 17, with the aid of which the guide rail 13 is to be attached to appropriate parts of the vehicle body. The flange 18 is bordered by two surfaces 19 and 20, which are parallel with each other and whose generatrix is a straight line extending at right angles with the longitudinal axis of the guide rail 13.

A guide groove 21, which is circular in cross section and opens via a slit 22 toward the front 14, is contained in the guide rail 13.

The guide rail 13 is for example made of an extruded aluminum profile.

Since the slit 22 is narrower than the diameter of the circular section of the guide groove 21, an undercut groove is created, which is suitable for protecting a linearly shaped thrust member against buckling and, by means of an appropriate cross section, to prevent the thrust member from passing through the slit 22 to the outside.

The guide rails 13 are bent in respect to several axes so that they follow the contour of the window edge without becoming visible in the window itself. The guide rails 13 are arranged in such a way that the grooves 21 open in a direction toward each other.

As FIG. 2 shows, the guide rails 13 extend downward through the slit 12 as far as below the rear window shelf 11.

As schematically indicated in FIG. 2, a windup shaft 23 is rotatably seated underneath the rear window shelf 11. Seating brackets for seating the windup shaft 23 are indicated at 24 in FIG. 5.

The windup shaft 23 is tube-shaped and houses a spring drive 25, which is schematically represented in FIG. 4. The spring drive 25 consists of a helical spring, whose one end is fixed in place in the interior of the windup shaft 23 and whose other end is anchored on one of the seating brackets 24 for seating the windup shaft 23.

A window shade web 26, whose shape is a trapezoidal approximation of the contour of the rear window 6, is fastened with one edge on the windup shaft 23. The edge remote from the windup shaft 23 is formed into a hose-shaped loop 27, in which a traction rod 28 is seated.

Parts of the traction rod 28 are essentially a center piece, covered by the loop 27, as well as two end pieces 29 and 30, which can be moved in a telescope-like manner in respect to the center piece.

The center piece is an oval tube of constant cross section respectively viewed over the length. The length of the tube corresponds to the length of the hose-shaped loop 27 and therefore to the corresponding edge of the window shade web 26.

The end pieces 29 and 30 have an L-shape and are composed of an arm 32 and a guide element 33. The arm 32 has a cross section of such a shape that it is longitudinally displaceable, greatly free of play, in the interior of said tube. At 34, its outer end makes a transition into the guide element 33, whose cross section is matched to the circular part of the guide groove 21, while the width of the arm 32 corresponds to the width of the slit 22.

The two end pieces 29 and 30 are identically embodied in respect to the arm 32 and the guide element 33.

A drive mechanism 35, which is represented in a greatly schematized manner in FIG. 4, is provided for extending the window shade web 26. To simplify the representation and to make the explanation of the invention easier, the two lateral guide rails 13 are represented in section in FIG. 4. The two guide grooves 21 open in a direction toward each other.

A gear motor 36 is a part of the drive mechanism 35, which is composed of a permanently excited d.c. motor 37 and a gear housing 38. Two guide channels 39 and 41 are contained parallel to each other in the gear housing 38, between which an output gear wheel 43 is provided on an output shaft 42. The output gear wheel 43 can be selectively put into motion in both directions of rotation by means of the output shaft 42, which is connected with it fixed against relative rotation.

A guide tube 44 runs from the guide channel 39 to the lower end of the guide groove 21 in the left guide rail 13. At the right end, the guide channel 41 is connected via a guide tube 45 with the lower end of the guide groove 21 in the right guide rail 13.

A flectionally elastic, linearly-shaped thrust member 46, or 47, extends through the guide channel 39, as well as through the guide channel 41. The respectively unused portion of the thrust members 46, 47 is pushed back into reservoir tubes, which extend from the respectively other ends of the guide channels 39, 41.

The two thrust members 46 and 47 are identically constructed. Each consists of an elastically flexible core 48, which has one or several ribs 49 on its exterior, which form a single- or multi-start screw thread. The ribs 49 protrude radially and run helically over the cylindrical core 48 from one end of the thrust member to the other end. The output gear wheel 43 has teeth which can enter between the grooves formed by the ribs 49. In this way the output gear wheel 43 is interlockingly coupled with the thrust members 46 and 47.

The mode of functioning of the described rear windup window shade is as follows:

In the position of rest, the windup shaft 23 has been rotated by the action of the spring drive 25 into a position in which the window shade web 26 is wound up. In this position the hose-like loop 27 is located in the outlet slit 11. The guide members 29, 30 are located in the vicinity of the lower ends of the two guide rails 13.

At the same time the two ends of the thrust members 46 and 47 are spaced apart from the respective guide elements 33.

If, starting from this position of the rear windup window shade 13, in which the entry of light into the vehicle interior is not hampered at all, the user would like to create a shading effect, he would extend the window shade web 26. The window shade web 26 reduces the entry of light, but without stopping it completely. For this purpose the window shade web 26 is made, for example, of an open chain weave, or a perforated plastic foil, which is colored black.

To extend the window shade web 26, the gear motor 36 is put into operation in a direction of rotation in which it moves the thrust member 47 toward the right through the guide groove 21. Since the two thrust members 46 and 47 mesh with the output gear wheel 43 at diametrically opposite ends, the thrust member 46 is simultaneously pushed forward toward the left through the guide groove 21 of the left guide rail 13. After a short distance over the advance path, the free ends of the two thrust members 46 and 47 come into engagement with the lower ends of the guide elements 33 of the two guide members 29 and 30, and in the further process push the guide members 29, 30 in the direction toward the upper end of the two guide rails 13.

Since the distance between the guide rails 13 changes, the legs 32 of the guide members 29, 30 simultaneously dip telescope-like into the dimensionally stable tube of the traction rod contained in the respective loop 27.

As soon as the end position has been reached, the gear motor 36 is stopped. The extended end position is represented in FIGS. 1 and 4.

The gear motor 36 is self-locking and arrests the thrust members 46 and 47 in their respectively reached positions.

The switch-off of the gear motor 36 is performed with the aid of limit stop switches, or in that the guide members 29 and 30 run up against stops, so that a blocking current occurs, which is evaluated in an electronic device and leads to switch-off.

The window shade web 26 is now held stretched between the traction rod and the windup shaft 23.

For retraction, the gear motor 36 is started in the opposite direction of rotation, so that the two guide members 46 and 47 are moved downward out of the associated guide rails 13.

The traction rod simultaneously moves downward, because the window shade web 26 is constantly kept under tension by the action of the spring drive 25 of the windup shaft 23.

The solution represented in FIG. 4 is also suited for rear window panes 9 which are curved in respect to horizontal, as well as vertical axes of curvature.

After the basic principle of the windup window shade 12 has been explained so far, aspects in accordance with the invention will be described by means of the following drawing figures, which make it possible to mount the windup window shade 12 in a simple manner at the assembly line for the motor vehicle 1. Here, only portions of the windup window shade 12 are shown for explaining the details in accordance with the invention, namely those portions which are important for understanding the invention.

One end of the windup shaft 23 can be seen in FIG. 5. In accordance with FIG. 5, the windup shaft 23 is rotatably seated between two seating brackets 24, only one of which is visible because of the broken off representation. The seating bracket 24 consists of a punched sheet metal element, bent in a C-shape. The punched sheet metal element constitutes a flat fastening leg 61 with a fastening bore 62, as well as a seating leg 63 extending at right angles with it and which contains a covered seating bore for a seating pin 64 of the windup shaft 23. Another leg 65 is formed on the end of the seating leg 63 remote from the fastening leg 61. The leg 65 is used for fastening the respective guide rail 13.

In the exemplary embodiment of FIG. 5, the guide rail 13 is composed of a first section 66 and a second section 67. The section 66 is fastened, for example by gluing or the like, in the angle area between the leg 65 and the seating leg 63 of the seating element 61. The length of the section 66 has been selected to be such that with the windup window shade 12 completely retracted, the free edge, or the free end of the section 66 projects past the guide members 29, or 30, viewed in the direction of movement during the extension.

A mirror-reversed arrangement of the seating bracket 24, which is provided in the same way with the section 66 of the guide rail 13 and in which the other end of the traction rod, or the other guide member 29 is guided, is located at the broken-off end of the windup shaft 23.

The two seating brackets 24 are connected with each other by a frame tubing 68. Both ends of the frame tubing 68 are, for example, welded together with respectively one of the seating legs 63. The seating legs 63 face each other, while the fastening legs 61 extend away from each other. The gear motor 36 is furthermore fastened to the frame tubing 68.

The guide tubes 44 and 45 each make a transition in one piece into the respective guide rail elements 66, as can be seen in FIG. 5. Thus, the guide tubes 44 and 45 respectively consist of a piece of profiled tubing, which has an interior profile in accordance with FIG. 3, wherein the lateral flange 18 is possibly missing.

As can be easily seen, the arrangement in accordance with FIG. 5 constitutes a unit which can be preassembled by the manufacturer of the windup window shade. The unit is composed of the seating brackets 24, which are connected rigidly and essentially immovably with each other by the frame tubing 68. The windup shaft 23 is rotatably seated between the two seating brackets 24, wherein the spring drive 25 is additionally supported, fixed against relative rotation, on one of the seating flanges 63. The end pieces 29, 30 of the traction rod have already been threaded into the piece 66 in the guide rail 13. The arms 32 of the guide members 29, 30 are pulled toward an edge of the seating leg 63 with the aid of the spring drive 25. The preassembled thrust members 46 and 47 are located in the further extent of the guide rail 13, which is constituted by the guide tube 44, or 45, and the gear motor 36 is preassembled on the frame tubing 68.

In this way it is quite easy to install this component into the respective motor vehicle on the assembly line, without requiring there the actual assembly of the windup window shade.

The second section 67 of the guide rails 13 is separate and is fastened in the vehicle body, for example following the mounting of the above mentioned component, which includes the windup shaft 23, and is plugged together with the section 66 of the guide rail 13, for example by means of a connecting sleeve, not represented. Prior to this, the section 67 had been fastened in the vehicle body with the aid of the flange 18. The way this is accomplished will be explained in connection with later drawing figures.

In place of completely separating the two sections 66 and 67 of the respective guide rail 13 and to plug them into each other only during assembly, there is also the possibility of providing a hinge joint, as represented in FIG. 6.

To the extent that components are used in this drawing figure which have already been explained, they are provided with the same reference numerals.

The leg 65 is extended past the end of the section 66 and forms a projecting bracket 69. The bracket 69 contains a hinge bore 71, in which a corresponding hinge pin 72 is seated, which is rigidly and solidly connected with the section 67. The hinge axis is located at right angles in respect to the axis of rotation of the windup shaft 23.

Initially the component in accordance with FIG. 6 is prepared in a manner similar to the component in accordance with FIG. 5. Then, in conclusion, the section 67 of the guide rail 13 is hinged on, for example in that the hinge bolt 72 is rotatably riveted to the bracket 69. It is now possible to deliver a component to the assembly line in which the guide rails 13 are already completely contained.

In the delivery state, the sections 67 of the guide rail 13 are folded in and extend parallel with the already threaded-in traction rod. After attachment to the vehicle body, for example by attaching the fastening flange 61 by means of screws or rivets, for which purpose it contains the bore 62, for example, the sections 67 are pivoted out of the position parallel with the windup shaft 23 into the position of use and fastened in the vehicle.

The connection between the section 67 and the section 66 of the guide rail can also be embodied as a predetermined bending point, as shown in FIG. 7. Here, the hinge consists of a predetermined bending point 73. The predetermined bending point 73 is achieved in that the profile of the guide rail 13 is provided with several cuts 74 from the back, which end shortly before the front wall 14. In this way two narrow strips remain at the sides of the slit 22. Following the complete mounting of the windup window shade 12, the two guide rail sections 67 of the two guide rails 13 are pivoted inward, so that the guide rails 13 are bent with a corresponding radius at the predetermined bending points 73. Following the installation of the fastening of the seating brackets 24, the guide rails 13 are again bent at the predetermined bending points 73 back into the desired position. In the process the predetermined bending points 73 act as hinges, which can be bent a sufficient number of times without breaking. It is important in this connection to assure a depth of the cuts 74 of sufficient dimensions.

In addition to the window, the vehicle body customarily is provided with an interior trim. The latter can be used for forming a section of the guide rail 13. FIG. 8 shows an embodiment, wherein the second section 67 of the guide rail 13 is not an individual guide rail profile. Instead, the section 67 is here contained in the form of a groove 75 in an interior trim element 76 of the C-column 4, or 5. In its cross section the groove 75 exactly corresponds to the groove 21 with the slit 22.

With this exemplary embodiment mounting takes place in that, following the attachment of the previously mentioned component, the interior trim elements 76 are fastened in the vehicle body. Positioning means, not represented, provide that the groove 75 is aligned with the groove 21 in the respective section 66.

FIG. 9 shows, in a greatly schematized way, how the guide rail 13 is connected with the body of the passenger car 1. A sectional view through the vehicle body of the motor vehicle 1 is represented in FIG. 9, namely a horizontal section, for example through the C-column 4. As can be seen, the C-column 4 is composed of two shaped sheet metal elements, an outer shaped sheet metal element 76 and an inner shaped sheet metal element 77. Since in connection with the invention only the area directly adjoining the rear window 6 is of interest, only this is schematically represented. The outer shaped sheet metal element 76 forms a fold 78 at the rear window 6, which terminates in a sheet metal flange 79. The inner shaped sheet metal element 77 is also provided with a fold 79 terminating in a flange 81. The two flanges 79 and 81 are straight flanges in the sense that their generatrix is a straight line extending at right angles to the edge and located in the plane of the rear window opening 6.

The two flanges 79 and 81 are connected with each other in a material-to-material way by spot welding. The rear window pane 9 is glued at the edge, if desired, with an interposition of a compensation and adhesive material 82.

The groove 21 is located inside the fold 80. The portion of the guide rail 13 extending on the side of the rear window opening 6 is fastened by means of the flange 18 on the surface of the inner shaped sheet metal element 77 pointing toward the vehicle interior next to the fold 80. Fastening takes place, for example, by means of screws or rivets, as schematically indicated at 83. The screws or rivets pass through bores in the flange 18 and the shaped sheet metal element 77.

It is understood that, at the lower edge, i.e. in the area of the lower window edge 8, the guide rail 13 slowly moves away from the flange 81 and leads away in the direction toward the seating brackets 24. The components as represented in FIGS. 5 and 8, are arranged, at least with the inclusion of the section 66 of the guide rail 13, below the rear window shelf 9, so that the guide rails 13 must of course move away from the fold 81 in this area.

The essential advantage of the arrangement in accordance with FIG. 9 consists in that the bulky portion of the guide rail 13, i.e. that portion with the guide groove 21, is contained in the inner fold 80, so that it does not add to an increase in the thickness of the vehicle body, inclusive of the interior trim, in this area. On the other hand, the guide rail 13 is in the immediate vicinity of the visible edge constituted by the free edge of the flange 79, or 81.

The fastening in accordance with FIG. 9 is also suitable for those parts of the vehicle body, such as a vehicle door, for example, at which there is no flange because the window panes are displaceably guided in guides.

FIG. 10 shows a connection wherein the flange 18 of the guide rail 13 is inserted between the flange 78 and the window pane 9. To this end the flange 18 is laterally offset, as shown, and terminates tangentially in the cross sectional area of the guide rail 13 in which the groove 21 is contained.

For fastening the guide rail 13 in accordance with FIG. 10, the flange 18 is glued to the exterior of the flange 79 by means of an adhesive material 84. The flange 18 itself again constitutes the support and holding surface for the window pane 9, which is fastened on the flange 18 in the same way as in FIG. 9 on the flange 79.

In the embodiment in accordance with FIG. 10 the inner edge of the window is directly constituted by the side 14 of the guide rail 13.

In FIG. 11, the flange 18 is not a straight strip bordered by two surfaces which are parallel to each other, instead the flange 18 is angled and is formed, for example, on the surface 15. By means of this a further groove 85 is created, which extends over the length of the guide rail 13 at least over the height of the window. The groove 85 is of such a size that it can receive a crimped leg 86 of the inner flange 81. For this purpose the flange 81 is crimped at its free edge pointing toward the center of the window opening 6 in order to form a leg which is distanced from the flange 78, on which the guide rail 13 can be pushed with the groove 85.

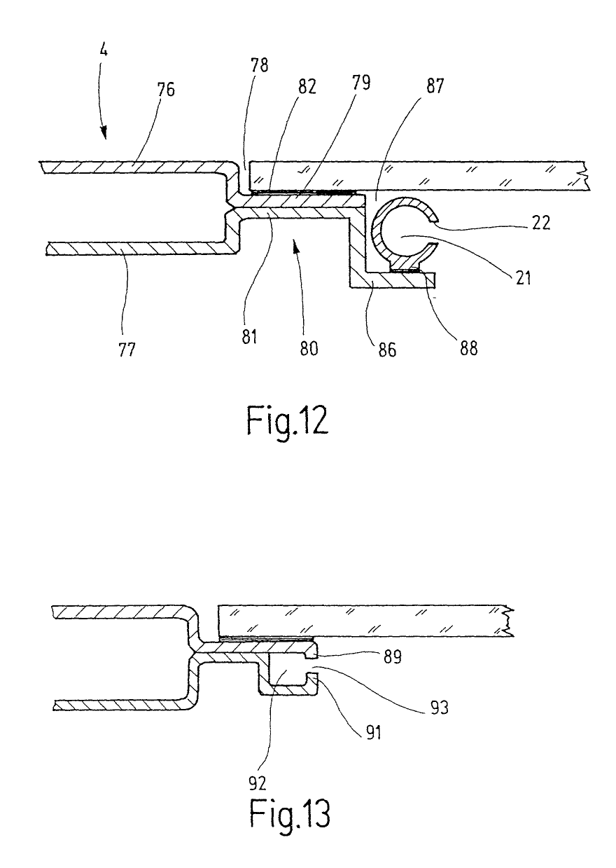

FIG. 12 shows an arrangement wherein the crimp as made in FIG. 11 has a greater spatial depth, so that the leg 86 is at a distance from the inside of the rear window pane 9 which permits the creation of a larger groove-shaped chamber 87. The dimensions of the groove-shaped chamber are sufficient for placing the guide rail 13 there. In this case the guide rail 13 is made without the flange 18 and instead has a straight lateral surface 88, with which it is glued to the leg 86. The guide rail 13 is located inside the chamber 87 between the leg 86 and the inside of the rear window pane 9.

The rear window pane 9 is fastened in the same way as had been explained in connection with FIG. 9.

As shown with some exemplary embodiments, it is not absolutely necessary for the exterior cross section of the guide rail 13 to be square. It can also be designed to be cylindrical.

FIG. 13 shows an exemplary embodiment wherein the section 67 of the guide rail 13 is constituted by the vehicle body itself. The flange 79 is provided with a one-piece strip 89 on its free end which points away from the window pane 9. On its free end the leg 86 also has a strip 91, which is aligned with the strip 89 and points toward it. A groove 92 with a slit 93 is created by this, which corresponds in cross section to the groove 21 with the slit 22. In the course of assembling the previously mentioned component, the section 66 is brought into an aligned connection with the groove 92, so that the complete guide rail 13 is created.

Moreover, FIGS. 9 to 13 easily show that the windup window shade 12 can be mounted before the window pane 9 is glued in. For this purpose the windup window shade 12 placed on the window opening from the outside and the guide rails 13 are connected from the outside with the flanges 79 and/or 81. Here the assembly can be even more simplified if, as shown in FIG. 14, the flange 65 of the seating bracket 24 is used as a mounting flange at the same time by having been extended for an appropriate length. In this case it is glued from the outside on the outside of the flange 79.

A windup window shade comprises a preassembled unit, consisting at least of the windup shaft, the associated seating elements and a frame tubing connecting the seating elements. In addition, the electric drive motor and guide tubes for guiding thrust members for actuating the windup window shade are part of the preassembled component. The windup window shade is connected with a traction rod, whose ends are guided in the guide rail elements, which are also a part of the component.

In a vehicle body a flange is provided for fastening a window pane. The flange is simultaneously used as a fastening for the guide rails so that the latter can approach the window pane opening as closely as possible without appearing as a distraction.

1. A windup window shade (12) for regulating the entry of light through a window into the interior of a motor vehicle, having
at least one windup shaft (23),
seating means (24), in which the windup shaft (23) is rotatably seated,
connecting means (68), with which the seating means (24) are connected with each other, wherein the seating means (24) and/or the connecting means (68) are arranged to be attached to the motor vehicle (1),
at least one window shade web (26), which is connected to the windup shaft (23) with one edge,
at least one pair of guide means (13), each one of which extends at least a piece away from the side next to the extended window shade web (26) and each of which contains at least one guide groove (21),
a traction rod (28), which is connected with an edge (27) of the window shade web (26) remote from the windup shaft (23) and whose ends are guided in the guide grooves (21), and
a drive mechanism (35) for moving the traction rod (28) along the guide rails (13) and for driving the windup shaft (23).

2. The windup window shade in accordance with claim 1, characterized in that the windup shaft (23) is tube-shaped and contains a spring drive (25), which is part of the drive mechanism (35).

3. The windup window shade in accordance with claim 1, characterized in that the seating means (24) have a mounting flange (61, 65) for fastening in the motor vehicle (1).

4. The windup window shade in accordance with claim 1, characterized in that the seating means (24) is a bent sheet metal element.

5. The windup window shade in accordance with claim 1, characterized in that the mounting flange (61, 65) is arranged to be fastened on the motor vehicle (1) in a material-to-material and/or interlocking connection.

6. The windup window shade in accordance with claim 1, characterized in that the window shade web (26) has been cut to approximate the window.

7. The windup window shade in accordance with claim 1, characterized in that the guide means (13) are connected, at least in sections, with the seating means (24) and the connecting means (68) to constitute a preassembled component.

8. The windup window shade in accordance with claim 1, characterized in that the guide means (13) are constituted by a guide rail, which contains an undercut groove (21).

9. The windup window shade in accordance with claim 1, characterized in that the guide means (13) extend in a manner corresponding to the associated edge of the window.

10. The windup window shade in accordance with claim 8, characterized in that the guide rail (13) is arranged to be fastened, at least in sections, to the motor vehicle (1) in a material-to-material and/or interlocking connection.

11. The windup window shade in accordance with claim 8, characterized in that the guide rail (13) is provided with at least one continuous surface (19, 20, 88), whose generatrix is a straight line extending at right angles in respect to the longitudinal axis of the guide rail (13).

12. The windup window shade in accordance with claim 8, characterized in that the guide rail (13) has two surfaces (19, 20), which are parallel to each other and whose generatrices are straight lines extending at right angles in respect to the longitudinal axis of the guide rail (13).

13. The windup window shade in accordance with claim 8, characterized in that on its side remote from the groove slit (22), the guide rail (13) is provided with a fastening flange (18) which is designed to be connected to the motor vehicle (1) in a material-to-material and/or interlocking manner.

14. The windup window shade in accordance with claim 8, characterized in that each guide rail (13) is divided into a first and a second section (66, 67), the first one (66) of which is connected with the seating means (24), wherein the length of the first section (66) is of such a size that it is capable of receiving the ends of the traction rod (28) when the window shade web (12) is in the completely retracted position.

15. The windup window shade in accordance with claim 14, characterized in that the first section (66) is of such a length that it extends only a short distance, related to the total length of the guide rail (13), past the traction rod (28) when the window shade web (12) is in the retracted position.

16. The windup window shade in accordance with claim 15, characterized in that the second section (67) is housed or formed in a lateral trim element (76) of the motor vehicle (1).

17. The windup window shade in accordance with claim 14, characterized in that the two sections (66, 67) are connected with each other via a hinge (71, 72, 73).

18. The windup window shade in accordance with claim 17, characterized in that the pivot axis (71) of the hinge (71, 72, 73) extends at right angles to the axis of rotation of the windup shaft (23).

19. The windup window shade in accordance with claim 17, characterized in that the hinge (71, 72, 73) is a film hinge or a predetermined bending point.

20. The windup window shade in accordance with claim 14, characterized in that the two sections (66, 67) of the guide rail (13) are connected with each other by means of a plug connection.

21. The windup window shade in accordance with claim 1, characterized in that the traction rod (28) consists of a center piece and two end pieces (29, 30), which can be moved in a telescope-like manner in relation to the center piece, wherein the end pieces (29, 30) are displaceably movable in the respective guide rail (13).

22. The windup window shade in accordance with claim 1, characterized in that the drive mechanism (35) has at least two drive members (46, 47), which are arranged drivingly between an electric drive motor (36) and the traction rod (28).

23. The windup window shade in accordance with claim 22, characterized in that the drive members (46, 47) are thrust members.

24. The windup window shade in accordance with claim 22, characterized in that the drive members (46, 47) are linearly-shaped members.

25. The windup window shade in accordance with claim 22, characterized in that the drive members (46, 47) have teeth (49) on their exterior circumferential surface.

26. The windup window shade in accordance with claim 22, characterized in that the drive mechanism (35) has a gear motor (36), on whose output shaft (42) a gear wheel (43) is seated, which acts together in an interlocked manner with the drive members (46, 47).

27. The windup window shade in accordance with claim 22, characterized in that guide tubes (44, 45), which extend from the drive motor (36) as far as an end of a respective guide rail (13), are provided for the drive members (46, 47).

28. The windup window shade in accordance with claim 27, characterized in that the guide tubes (44, 45) have the same cross-sectional profile as the guide rails (13).

29. The windup window shade in accordance with claim 26, characterized in that the gear motor (36) is attached to the connecting means (68).

30. The windup window shade in accordance with claim 1, characterized in that the connecting means (68), the seating means (24), together with the windup shaft (23), the guide tubes (44, 45), the drive motor (36) and at least sections (66) of the guide 5 rails (13) constitute a preassembled unit for mounting in the vehicle (1).

31. The windup window shade in accordance with claim 1, characterized in that at least one section (67) of the guide rails (13) is an integral part of a door or a body of the vehicle.

32. A body or a door for a motor vehicle (1), having at least one window opening (6), which has a circumferential window edge, a window shade web (12), parts of which are:
a windup shaft (23) which is rotatably seated in seating means (24),
at least one window shade web (26), which is connected to the windup shaft (23) with one edge (27),
at least one pair of guide rails (13), each one of which extends laterally next to the extended window shade web (26) and each of which contains at least one guide groove (21), wherein the guide rails (13) are provided at least in sections at or next to the window edge,
a traction rod (28), which is connected with an edge of the window shade web (26) remote from the windup shaft (23) and whose ends are guided in the guide grooves (21), and
a drive mechanism (35) for moving the traction rod (28) along the guide rails (13) and for driving the windup shaft (23).

33. The body or door in accordance with claim 32, characterized in that the window opening (6) contains a flange (79, 81) extending along the window edge and intended for fastening a window pane (9), and that the guide rails (13) are provided on or next to the flange (79, 81).

34. The body or door in accordance with claim 33, characterized in that the flange (79, 81) is formed by sheet metal sections placed on top of each other and shaped in such a way that they define a guide groove (92) between them.

35. The body or door in accordance with claim 33, characterized in that a strip (86) is formed on the flange (79, 81) to which the guide rail (13) is to be fastened.

36. The body or door in accordance with claim 32, characterized in that the window opening (6) has at least one double fold (78, 87) on the side, wherein the window pane (9) is fastened on its outer stage (79), while the inner one (87) is used as a support for the guide rail (13).

37. The body or door in accordance with claim 33, characterized in that the guide rail (13) has a flange (18), which has been introduced between the window pane (9) and the flange (79, 81).

38. The body or door in accordance with claim 32, characterized in that the length of the traction road (28) can be changed in such a way that it is capable of following the changing distance between the guide rails (13).

39. The body or door in accordance with claim 32, characterized in that the windup shaft (23) is tube-shaped and contains a spring drive (25) which is part of the drive mechanism (35).

40. The body or door in accordance with claim 32, characterized in that the seating means (24) have a mounting flange (62, 65) for fastening in the motor vehicle.

41. The body or door in accordance with claim 32, characterized in that the seating means (24) are a bent sheet metal element.

42. The body or door in accordance with claim 40, characterized in that the mounting flange (62, 65) is designed for a connection to the motor vehicle (1) in a material-to-material and/or interlocking manner.

43. The body or door in accordance with claim 32, characterized in that the window shade web (26) has been cut to approximate the window.

44. The body or door in accordance with claim 32, characterized in that the guide means (13) extend in a manner corresponding to the associated edge of the window.

45. The body or door in accordance with claim 32, characterized in that the guide rail (13) is arranged to be fastened to the motor vehicle in a material-to-material and/or interlocking connection.

46. The body or door in accordance with claim 32, characterized in that the guide rail (13) is provided with at least one continuous surface (19, 20, 88), whose generatrix is a straight line extending at right angles in respect to the longitudinal axis of the guide rail (13).

47. The body or door in accordance with claim 32, characterized in that the guide rail (13) has two surfaces (19, 20), which are parallel to each other and whose generatrices are straight lines extending at right angles in respect to the longitudinal axis of the guide rail.

48. The body or door in accordance with claim 32, characterized in that on its side (17) remote from the groove slit (22), the guide rail (13) is provided with a fastening flange (18) which is designed to be connected to the motor vehicle in a material-to-material and/or interlocking manner.

49. The body or door in accordance with claim 32, characterized in that each guide rail (13) is divided into a first and a second section (66, 67), the first one of which is connected with the seating means (24), wherein the length of the first section (66) is of such a size that it is capable of receiving the ends of the traction rod (28) when the window shade web (12) is in the completely retracted position.

50. The body or door in accordance with claim 49, characterized in that the first section (66) is of such a length that it extends only a short distance, related to the total length of the guide rail (13), past the traction rod (28) when the window shade web (12) is in the retracted position.

51. The body or door in accordance with claim 49, characterized in that the two sections (66, 67) are connected with each other via a hinge (71, 72, 73).

52. The windup window shade in accordance with claim 51, characterized in that the pivot axis (71) of the hinge (71, 72, 73) extends at right angles to the axis of rotation of the windup shaft (23).

53. The body or door in accordance with claim 51, characterized in that the hinge (71, 72, 73) is a film hinge or a predetermined bending point.

54. The body or door in accordance with claim 49, characterized in that the two sections (66, 67) of the guide rail (13) are connected with each other by means of a plug connection.

55. The body or door in accordance with claim 32, characterized in that the traction rod (28) consists of a center piece and two end pieces (29, 30), which can be moved in a telescope-like manner in relation to the center piece, wherein the end pieces (29, 30) are displaceably movable in the respective guide rail (13).

56. The body or door in accordance with claim 32, characterized in that a section (67) of the guide rail (13) is constituted by an interior trim element (76) of the vehicle.

57. The body or door in accordance with claim 32, characterized in that the drive mechanism (35) has at least two drive members (46, 47), which are arranged drivingly between an electric drive motor (36) and the traction rod (28).

58. The body or door in accordance with claim 57, characterized in that the drive members (46, 47) are thrust members.

59. The body or door in accordance with claim 57, characterized in that the drive members (46, 47) are linearly-shaped members.

60. The body or door in accordance with claim 57, characterized in that the drive members (46, 47) have teeth (49) on their exterior circumferential surface.

61. The body or door in accordance with claim 57, characterized in that the drive mechanism (35) has a gear motor (36), on whose output shaft (42) a gear wheel (43) is seated, which acts together in an interlocked manner with the drive members (46, 47).

62. The body or door in accordance with claim 57, characterized in that guide tubes (44, 45), which extend from the drive motor (36) as far as an end of a respective guide rail (13), are provided for the drive members (46, 47).

63. The body or door in accordance with claim 62, characterized in that the guide tubes (44, 45) have the same cross-sectional profile as the guide rails (13).

64. The body or door in accordance with claim 32, characterized in that the gear motor (36) is attached to the connecting means (68).

65. The body or door in accordance with claim 32, characterized in that the connecting means (68), the seating means (24), the windup shaft (23), the guide tubes (44, 45), the drive motor (36) and at least sections (66) of the guide rails (13) constitute a preassembled unit for mounting in the vehicle.
